(19) United States
(12) Patent Application Publication
(10) Pub. No.: US 2006/0045229 A1
(43) Pub. Date: Mar. 2, 2006

(54) Protective housing for radionuclide generator and combination thereof

(76) Inventor: Ernest Balestracci, Iselin, NJ (US)

Correspondence Address: BRACCO RESEARCH USA INC., 305- COLLEGE ROAD EAST, PRINCETON, NJ, 08540, US

(21) Appl. No.: 10/928,635

(22) Filed: Aug. 28, 2004

(51) Int. Cl. G21C 1/04

(52) U.S. Cl. 376/347

(57) ABSTRACT

A protective cover and radionuclide generator assembly. The cover protecting inlet and outlet connections disposed on the radionuclide generator. The radionuclide generator having a distal end having a generally flat top surface. The protective cover removably fixed at the distal end and positioned over the generally flat top surface. The protective cover engaging with the radionuclide generator and providing an interference fit. The interference fit preventing the removal of the cover from the radionuclide generator, unless so desired by a user. The cover being made from a radioactive resistant polypropylene.

### FIELD OF THE INVENTION

The present invention relates to a protective housing for a radionuclide generator. More particularly, the invention relates to a protective housing that covers and protects the inlet and outlet connections of the radionuclide generator.

### BACKGROUND OF THE INVENTION

The use of radionuclides for the diagnosis and treatment of various medical conditions is widespread. In diagnostic procedures it is desirable for a diagnostician to be able to clearly view the tissue of interest, such as, for example, a patient's heart. Some radioactive isotopes have an extremely short half-life. Thus, using them is very desirable in diagnosis since they minimize prolonged radiation exposure to the patient, but provide clear images to the medical diagnostician.

In practice, these desirable radioactive isotopes are often provided by a radionuclide nuclear generator, such as Bracco Diagnostic's model Cardiogen 82 (Rubidium RB 82 Generator), model # 001500. The radionuclide generators are typically used up to 168 times in a one month time frame.

The generator typically includes an inlet connection and an outlet connection. Since the generator may be used up to 168 times the connections often get crushed or kinked. If the inlet or outlet connection becomes damaged, the generator will be rendered unusable. Therefore, it would be desirable to provide a protective cover that prevents the inlet and outlet connections from becoming damaged in combination with the radionuclide generator.

### SUMMARY OF THE INVENTION

In accordance with the present invention, a radionuclide generator assembly is provided. The radionuclide generator assembly includes a radionuclide generator that has a distal end and a protective cover that is removably fixed at the distal end. The protective cover comprises a radioactive resistant polypropylene.

In another embodiment of the present invention a cover and radionuclide generator assembly is provided. The radionuclide generator assembly includes a radionuclide generator. The radionuclide generator includes a bucket and a distal end that has a generally flat top surface. The cover includes a protective cover that is removably fixed and positioned over the generally flat top surface.

In another embodiment of the present invention a protective cover for a radionuclide generator is provided. The cover provides a housing which covers the inlet and outlet ports of the radionuclide generator and struts for releasably engaging the radionuclide generator.

In another embodiment of the present invention a protective cover for a radionuclide generator is provided. The cover includes a generally rectangular housing that has a distal end, a generally flat top surface, a first pair of side portions connected to the top surface, a second pair of side portions connected to the top surface. The cover also includes a semicircular notch that is disposed on each of the pair of first side portions, a bottom surface that is connected to the first and second pairs of side portions and at least two struts that are connected to the bottom surface and project away from the generally flat top surface.

In another embodiment the above referenced cover may optionally be combined with a radionuclide generator. The radionuclide generator having an inlet port entering the radionuclide generator from a generally flat top surface, an outlet port exiting the radionuclide generator from a generally flat top surface and a u-shaped handle connected to the bucket. The u-shaped handle having a bottom portion and a semicircular top portion that is designed to be contiguous with the semicircular notch that is disposed on each of the first pair of side portions of the protective cover.

The at least two struts may optionally provide a ribbed portion. The ribbed portion of the at least two struts engage the bottom portion of the handle of the bucket such that the engagement prevents the cover from being removed from the handle.

The at least two struts may optionally provide four struts and each of the four struts may optionally provide a ribbed portion.

In another embodiment of the present invention a combination protective cover and a radionuclide generator assembly is provided. The assembly includes a radionuclide generator that has a bucket and a distal end having two generally flat top surfaces. The two generally flat top surfaces having a first distance D₁. The radionuclide generator further includes an inlet port that enters from the generally flat top surface, an outlet port that exits from the generally flat top surface and a handle that is connected to the bucket. The handle provides a bottom portion and a semicircular top portion. The semicircular top portion has a third distance D₃.

The protective cover is positioned over the inlet and outlet ports, the semicircular top portion of the handle and the generally flat top surface of the distal end. The protective cover provides a generally rectangular housing that has a top portion and a first pair of side portions having corresponding inner surfaces. The first pair of side portions are connected to the top portion and have a second distance D₂ that lies between the inner surfaces. The generally rectangular housing also provides a second pair of side portions that are connected to the top portion, a semicircular notch on each of the first pair of side portions and a bottom surface that is connected to the first and second pairs of side portions.

The protective cover also provides at least two struts that are connected to the bottom surface. The at least two struts project away from the top portion. The at least two struts have an outer surface and a fourth distance D₄ that lies between the outer surfaces. The first distance D₁ is about equal to the second distance D₂ and the third distance D₃ is about equal to the fourth distance D₄. The about equal distances D₁ and D₂ provide an interference fit between the at least two struts and the generally rectangular top surface. The about equal distances D₃ and D₄ provide an interference fit between the outer surfaces of the struts and the semicircular top portion of the handle.

In another embodiment of the present invention a combination protective cover and a radionuclide generator assembly is provided. The assembly includes a radionuclide generator that has a bucket, a distal end having two generally flat top surfaces. The two generally flat top surfaces having a first distance D₁. The radionuclide generator further includes an inlet port that enters from the generally flat top surface, an outlet port that exits from the generally flat top surface and a handle that is connected to the bucket. The handle provides a bottom portion and a semicircular top portion. The semicircular top portion has a third distance D₃.

The protective cover is positioned over the inlet and outlet ports, the semicircular top portion of the handle and the generally flat top surface of the distal end. The protective cover provides a generally rectangular housing that has a top portion and a first pair of side portions having corresponding inner surfaces. The first pair of side portions are connected to the top portion and have a second distance D₂ that lies between the inner surfaces. The generally rectangular housing also provides a second pair of side portions that are connected to the top portion, a semicircular notch on each of the first pair of side portions and a bottom surface that is connected to the first and second pairs of side portions.

The protective cover also provides at least two struts that are connected to the bottom surface. The at least two struts project away from the top portion and have an outer surface, a rib disposed on the outer surface and a fourth distance D₄ lying between the outer surfaces. The first distance D₁ is about equal to the second distance D₂ and the third distance D₃ is about equal to the fourth distance D₄. The about equal distances D₁ and D₂ provide an interference fit between the at least two struts and the generally rectangular top surface. The about equal distances D₃ and D₄ provide an interference fit between the outer surfaces of the struts and the semicircular top portion of the handle. The ribbed portion of each strut latches and engages the bottom portion of the handle such that the engagement prevents removal of the cover from the radionuclide generator.

### BRIEF DESCRIPTION OF THE DRAWINGS

FIG. 1 is a perspective view of the protective housing and radionuclide generator in combination;

FIG. 2 is a top plan view of the radionuclide generator;

FIG. 3 is a perspective view of a protective housing of the present invention;

FIG. 4 is a further perspective view of the protective housing of the present invention; and

FIG. 5 is a side perspective view of the protective housing and radionuclide generator combination of the present invention;

FIG. 6 is a perspective view of an alternate embodiment of a protective housing of the present invention.

FIG. 7 is a perspective view of an alternate embodiment of a protective housing of the present invention.

FIG. 8 is a perspective view of an alternate embodiment of a protective housing of the present invention.

### DETAILED DESCRIPTION OF THE INVENTION

While the invention includes embodiments in many different forms, there is shown in the drawings and will herein be described in detail preferred embodiments of the invention with the understanding that the present disclosure is to be considered as exemplary of the principles of the invention and is not intended to limit the invention to the embodiments illustrated.

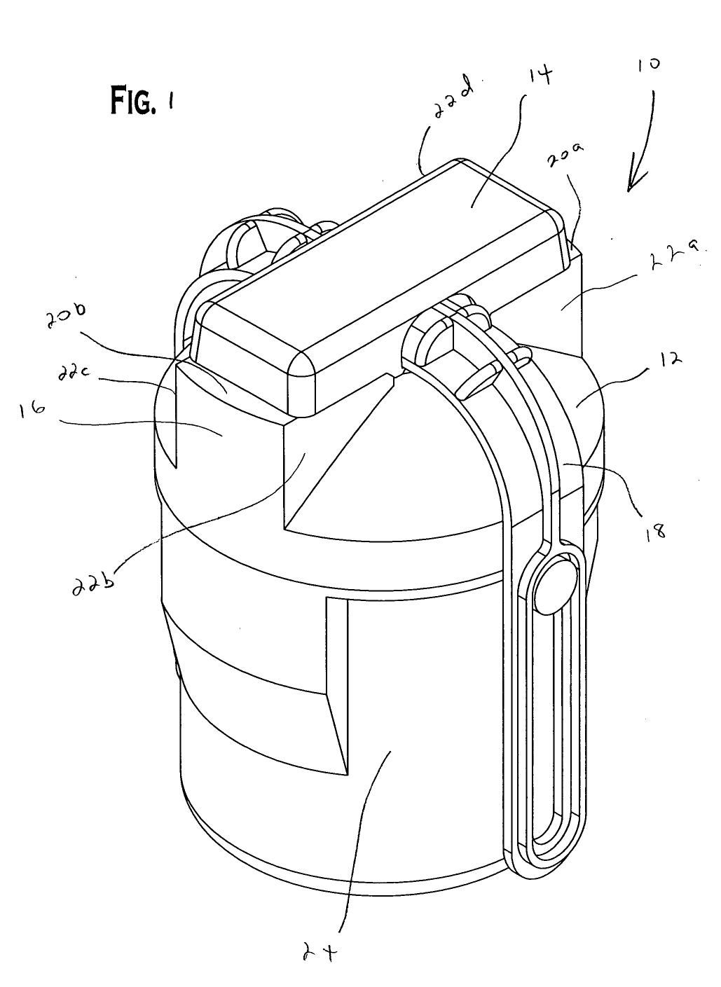

Referring to FIG. 1, there is shown in perspective view a radionuclide generator assembly of the present invention. Radionuclide generator assembly 10 comprises a protective housing or cover 14 of the invention and a radionuclide generator 12. Radionuclide generator 12 includes a distal end 16, a unshaped handle 18 and a bucket 24 that contains a lead liner (not shown) and a column containing the radionuclide (not shown).

For purposes of the description of the radionuclide generator and present invention, the term “distal end” refers to the end closest to the end having the inlet and outlet connections, whereas the term “proximal end” refers to the end furthest from the end having the inlet and outlet connections.

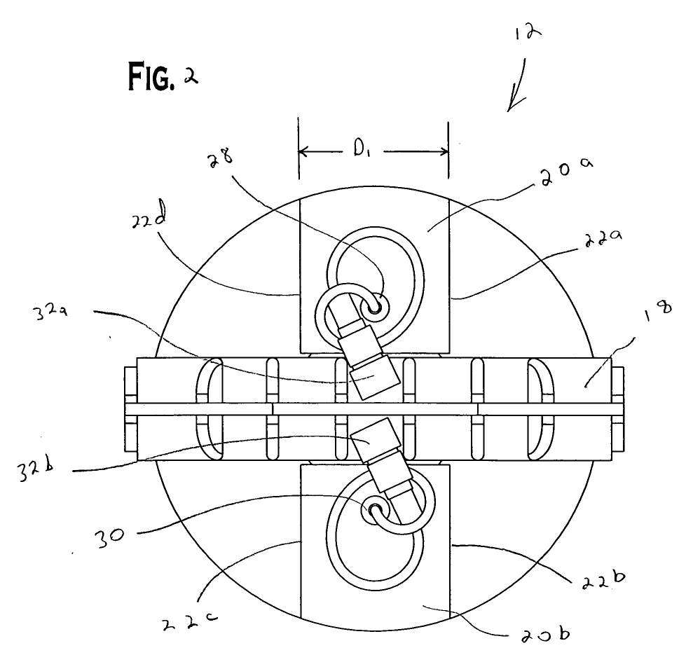

The distal end 16 includes generally flat top surfaces 20a and 20b and generally flat side surfaces 22a, 22b, 22c and 22d. Referring now to FIG. 2, there is shown a top plan view of the radionuclide generator 12. A first distance D₁ spans across the generally flat top surfaces 20a and 20b of the radionuclide generator 12.

Generally flat top surface 20a includes an inlet port 28. Saline (not shown) enters the radionuclide generator 12 through an inlet connector assembly 32a and activates the radionuclide generator to create the desired isotope, such as, for example, rubidium (not shown). Inlet connector assembly 32a enters the radionuclide generator 12 through inlet port 28. Inlet connector assembly 32a is directly connected to the column that is housed within the radionuclide generator 12.

Generally flat top surface 20b includes an outlet port 30. The radionuclide exits the radionuclide generator 12 through outlet port 30. Outlet connector assembly 32b exits the radionuclide generator 12 through outlet port 30. Outlet connector assembly 32b is directly connected to the column that is housed within the radionuclide generator 12.

It should be recognized by those skilled in the art that the location of the inlet and outlet ports need not be limited to their exact positions as shown in FIG. 2. That is, they may, for example, be reversed so that the inlet port is in the location of the outlet port and the outlet port is in the location of the inlet port. This applies to the inlet and outlet connections as well.

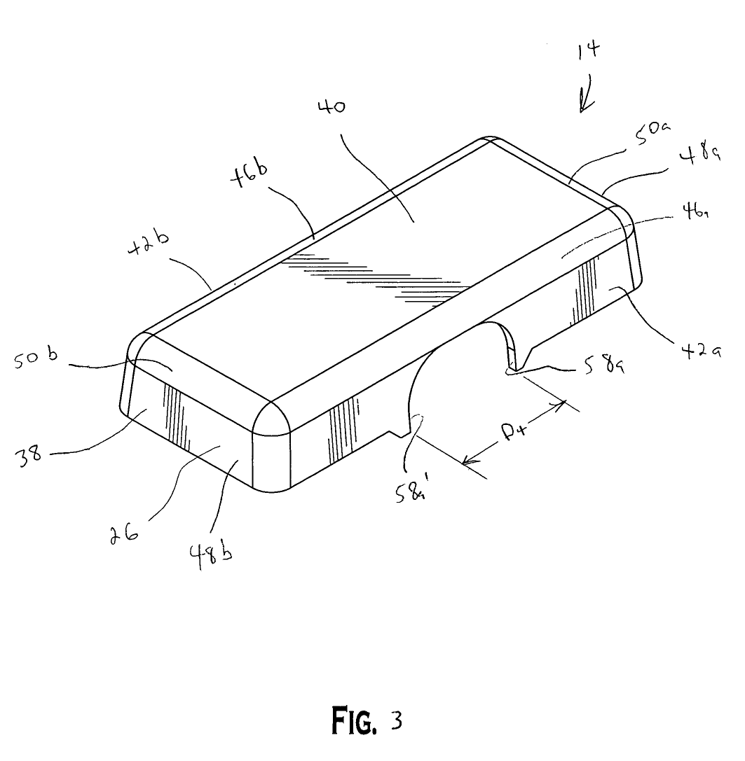

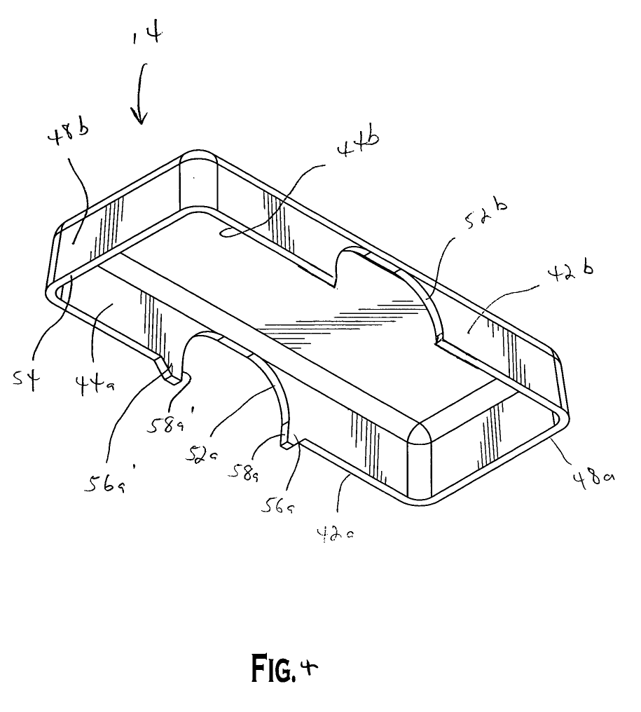

Referring now to FIGS. 3-4; there are shown two separate perspective views of the protective cover 14. The protective cover 14 is made from a radioactive resistant material such as polypropylene. One such supplier of the radioactive resistant polypropylene material is Huntsman Polyurethanes. Huntsman Polyurethanes is located at 2190 Executive Hills Boulevard, Auburn Hills, Mich. 48326. Their material designation for the radioactive resistant polypropylene is Huntsman H1200 PP.

The protective cover 14 includes a housing 38. In a preferred embodiment the housing 38 is generally rectangular; however, the invention includes housings of any shape or configuration sufficient to cover the inlet 28 and outlet 30 ports and to engage with the radionuclide generator such that the cover will only be removed when desired by the user. In a preferred embodiment, the protective cover engages with the radionuclide generator to provide an interference fit such as that described in more detail below.

In the embodiment depicted in FIGS. 3-4, the generally rectangular housing 38 includes a top portion 40 and a first pair of side portions 42a and 42b. The first pair of side portions 42a and 42b have corresponding inner surfaces 44a and 44b. The first pair of side portions 42a and 42b are connected to the top portion 40 at a first pair of intersections 46a and 46b.

The generally rectangular housing 38 also includes a second pair of side portions 48a and 48b. The second pair of side portions 48a and 48b are connected to the top portion 40 at a second pair of intersections 50a and 50b. It should be recognized by those skilled in the art that the first pair of intersections 46a and 46b and the second pair of intersections 50a and 50b should not be limited to being a particular radius. Additionally, the intersections may optionally be configured to meet to form a right angle.

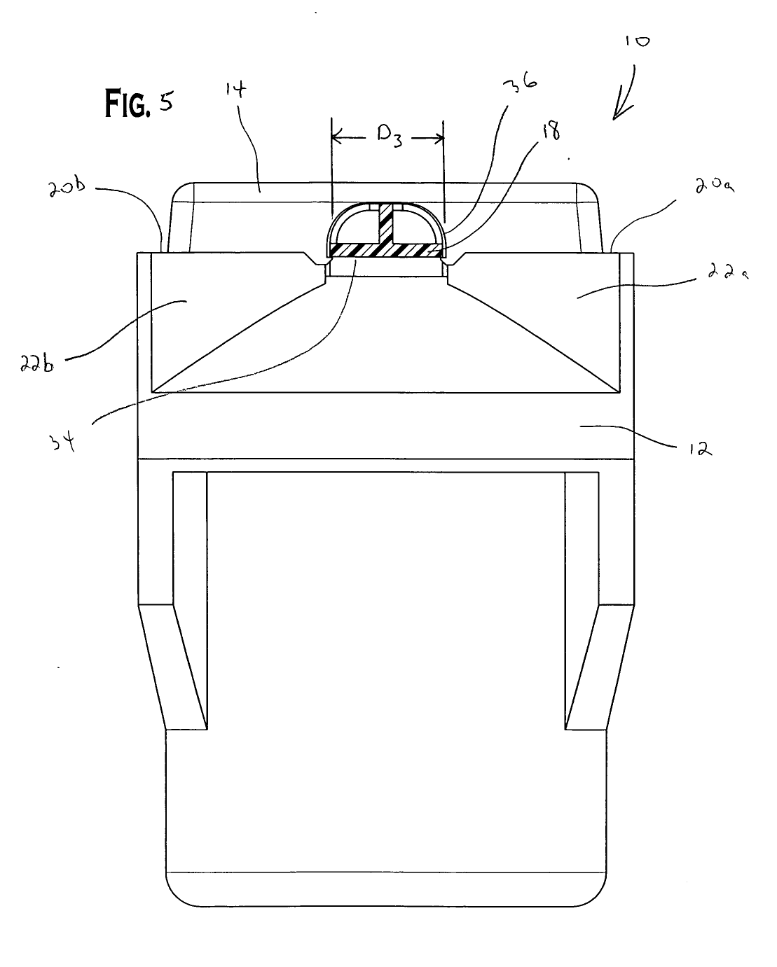

The first pair of side portions 42a and 42b each include a semicircular notch 52a and 52b that is respectively disposed on each of the first pair of side portions. The protective cover 14 also includes a bottom surface 54 that is connected to the first and second pairs of side portions 42a, 42b, 48a and 48b. The first side portion 42a includes at least two struts 56a and 56a′ that are connected to the bottom surface 54 and semicircular notch 52a. The at least two struts 56a and 56a′ project away from the top portion 40. The at least two struts 56a and 56a′ have outer surfaces 58a and 58a′ respectively. A fourth distance D₄ spans across the outer surfaces 58a and 58a′. One embodiment is illustrated in FIGS. 1-5. FIG. 5 shows a side perspective view of the radionuclide assembly 10 of the present invention. The u-shaped handle 18 includes a bottom portion 34 and a semicircular top portion 36. A third distance D₃ spans across the semicircular top portion 36 of the handle 18.

The protective cover 14 is positioned over the inlet 28 and outlet 30 ports, the semicircular top portion 36 of the u-shaped handle 18 and the generally flat top surfaces 20a and 20b of the distal end 16. The semicircular top portion 36 is designed to be contiguous with the semicircular notches 52a and 52b that are disposed on each of the first pair of side portions 42a and 42b respectively.

The third distance D₃ is about equal to the fourth distance D₄. Since the distances D₃ and D₄ are about equal, an interference fit is created between the outer surfaces 58a and 58a′ of the cover 14 and the semicircular top portion 36 of the handle 18. The range of the interference fit is about (0.002) mm-(0.005) mm.

The interference fit keeps the cover 14 positioned over the radionuclide generator 12 so that the inlet and outlet connector assemblies 32a and 32b are protected from any damage that may occur during handling. In use, the protective cover 14 may be removed by holding the protective cover 14 and lifting it off of the assembly 10. The protective cover 14 is secured to the assembly 10 such that it is held snug enough that the protective cover 14 will not fall off during handling.

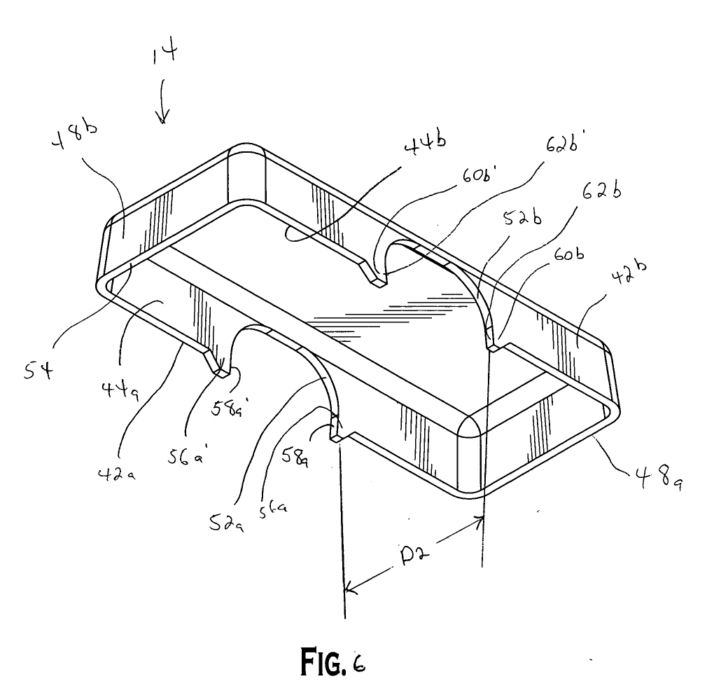

Referring to FIG. 6, there is shown an alternate embodiment of the protective cover 14. In this embodiment, the protective cover is the same as described above except the second side portion 42b may optionally provide two additional struts 60b and 60b′. The two additional struts 60b and 60b′ are configured the same as struts 56a and 56a′ described above. A second distance D₂ lies between struts 56a, 56a′, 60b and 60b′.

Since the distances D₁ and D₂ are about equal, a further interference fit is created between struts 56a, 56a′, 60b and 60b′ of the cover 14 and the generally rectangular top surfaces 20a and 20b of the radionuclide generator 12. The range of the interference fit is about (0.002) mm-(0.005) mm.

The engagement prevents removal of the cover 14 from the radionuclide generator 12 unless so desired by a user, such as a diagnostician.

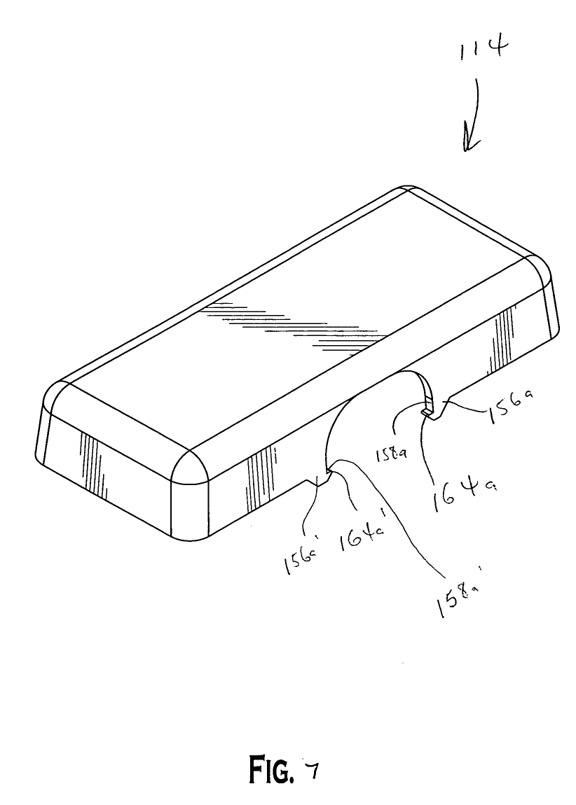

Referring to FIG. 7, there is shown an alternate embodiment of the protective cover. Protective cover 114 is identical to the protective cover 14 that was described in connection with FIG. 3 above except that struts 156a and 156a′ have ribs 164a and 164a′ that are disposed on outer surfaces 158a and 158a′. The ribs 164a and 164a′ latch and engage the bottom portion 34 of the handle 18. The engagement further prevents removal of the cover 114 from the radionuclide generator 12 unless so desired by a user.

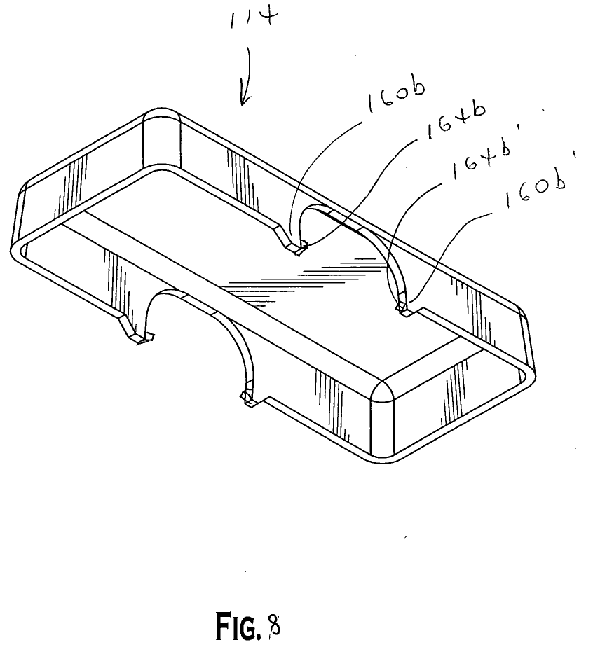

Referring to FIG. 8, there is shown another alternate embodiment of the protective cover. The protective cover 114 in this embodiment is the same as the protective cover disclosed in connection with FIG. 7, except the protective cover 114 may include two additional struts 160b and 160b′ that have two additional corresponding ribs 164b and 164b′. The additional ribs 164b and 164b′ latch and engage the bottom portion 34 of the handle 18. This engagement additionally prevents removal of the protective cover 114 from the radionuclide generator 12 unless so desired by the user.

1. A radionuclide generator assembly comprising:
a) a radionuclide generator having a distal end; and
b) a protective cover removably fixed at the distal end.

2. The protective cover according to claim 1 wherein the cover comprises a radioactive resistant polypropylene.

3. A cover and radionuclide generator assembly comprising:
a) a radionuclide generator comprising:
1) a bucket; and
2) a distal end having a generally flat top surface; and
b) a protective cover removably fixed positioned over the generally flat top surface.

4. The protective cover according to claim 3 wherein the cover comprises a radioactive resistant polypropylene.

5. A protective cover for a radionuclide generator comprising:
a) a housing which covers the inlet and outlet ports of the radionuclide generator
b) struts for releasably engaging the radionuclide generator.

6. A protective cover for a radionuclide generator comprising:
a) a generally rectangular housing having a distal end and comprising:
1) a generally flat top surface;
2) a first pair of side portions connected to the top surface;
3) a second pair of side portions connected to the top surface;
4) a semicircular notch disposed on each of the pair of first side portions; and
5) a bottom surface connected to the first and second pairs of side portions; and
b) at least two struts connected to the bottom surface and projecting away from the generally flat top surface.

7. The cover according to claim 6 in combination with a radionuclide generator, the radionuclide generator comprising:
a) an inlet port entering the radionuclide generator from a generally flat top surface;
b) an outlet port exiting the radionuclide generator from a generally flat top surface;
c) a u-shaped handle connected to the bucket, the u-shaped handle having a bottom portion and a semicircular top portion designed to be contiguous with the semicircular notch disposed on each of the first pair of side portions of the protective cover.

8. The combination according to claim 7 wherein the at least two struts further comprise a ribbed portion.

9. The combination according to claim 8 wherein the ribbed portion of the at least two struts engage the bottom portion of the handle of the bucket such that the engagement prevents the cover from being removed from the handle.

10. The protective cover according to claim 6 wherein the cover is made from a radioactive resistant polypropylene.

11. The protective cover according to claim 6 wherein the at least two struts further comprise four struts.

12. The protective cover according to claim 11 wherein each of the four struts further comprises a ribbed portion.

13. A combination protective cover and a radionuclide generator assembly comprising:
a) a radionuclide generator having;
1) a bucket;
2) a distal end having two generally flat top surfaces, the two generally flat top surfaces having a first distance D₁;
3) an inlet port entering from the generally flat top surface;
4) an outlet port exiting from the generally flat top surface; and
5) a handle connected to the bucket, the handle having a bottom portion and a semicircular top portion, the semicircular top portion having a third distance D₃;
b) a protective cover positioned over the inlet and outlet ports, the semicircular top portion of the handle and the generally flat top surface of the distal end, the protective cover comprising:
1) a generally rectangular housing comprising:
a) a top portion;
b) a first pair of side portions having corresponding inner surfaces, the first pair of side portions connected to the top portion and having a second distance D₂ that lies between the inner surfaces;
c) a second pair of side portions connected to the top portion;
d) a semicircular notch on each of the first pair of side portions; and
e) a bottom surface connected to the first and second pairs of side portions; and
2) at least two struts connected to the bottom surface and projecting away from the top portion, the at least two struts having;
a) an outer surface; and
b) a fourth distance D₄ that lies between the outer surfaces;
wherein the first distance D₁ is about equal to the second distance D₂ and the third distance D₃ is about equal to the fourth distance D₄; and
wherein the about equal distances D₁ and D₂ provide an interference fit between the at least two struts and the generally rectangular top surface and the about equal distances D₃ and D₄ provide an interference fit between the outer surfaces of the struts and the semicircular top portion of the handle.

14. A combination protective cover and a radionuclide generator assembly comprising:
a) a radionuclide generator having;
1) a bucket containing a lead liner and a column of radionuclide;
2) a distal end having a generally flat top surface and generally rounded side surfaces, the generally flat top surface having a first distance D₁;
3) an inlet port entering from the generally flat top surface;
4) an outlet port exiting from the generally flat top surface; and
5) a handle connected to the bucket, the handle having a bottom portion and a semicircular top portion having a third distance D₃;
b) a protective cover positioned over the inlet and outlet ports, the semicircular top portion of the handle and the generally flat top surface of the distal end, the protective cover comprising:
1) a generally rectangular housing comprising:
a) a top portion;
b) a first pair of side portions having corresponding inner surfaces, the first pair of side portions connected to the top portion and having a second distance D₂ that lies between the inner surfaces;
c) a second pair of side portions connected to the top portion;
d) a semicircular notch disposed on each of the first pair of side portions; and
e) a bottom edge; and
2) at least two struts connected to the bottom surface and projecting away from the top portion, each strut having;
a) an outer surface;
b) a rib disposed on the outer surface; and
c) a fourth distance D₄ lying between the outer surfaces; and
wherein the first distance D₁ is about equal to the second distance D₂ and the third distance D₃ is about equal to the fourth distance D₄; and
wherein the about equal distances D₁ and D₂ provide an interference fit between the at least two struts and the generally rectangular top surface and the about equal distances D₃ and D₄ provide an interference fit between the outer surfaces of the struts and the semicircular top portion of the handle; and
wherein the ribbed portion of each strut latches and engages the bottom portion of the handle such that the engagement prevents removal of the cover from the radionuclide generator.

15. The combination according to claim 14 wherein the cover is made from a radioactive resistant polypropylene.
